(19) United States
(12) Patent Application Publication
(10) Pub. No.: US 2009/0187551 A1
(43) Pub. Date: Jul. 23, 2009

(54) SEARCH RESULTS WHEN SEARCHING FOR RECORDS OF A BUSINESS OBJECT

(75) Inventors: Yu Cong Lam, San Jose, CA (US); Paolo Juvara, Pamplona (ES)

Correspondence Address: TOWNSEND AND TOWNSEND AND CREW LLP, TWO EMBARCADERO CENTER, 8TH FLOOR, SAN FRANCISCO, CA, 94111-3834, US

(73) Assignee: Oracle International Corporation, Redwood Shores, CA (US)

(21) Appl. No.: 12/015,606

(22) Filed: Jan. 17, 2008

(51) Int. Cl. G06F 17/30

(52) U.S. Cl. 707/5; 707/E17.064

(57) ABSTRACT

Embodiments of the invention provide systems and methods for searching records of a business object using a keyword search. According to one embodiment, a method of searching for one or more records of a business object can comprise converting one or more records of the business object to one or more keyword lists and searching for records of the business object based on the keyword lists and the search criteria. Converting records of the business object to one or more keyword lists can comprise converting one or more attributes of each of the records to one or more keyword-value pairs and saving the keyword-value pairs in the keyword lists. Searching for records of the business object based on the keyword lists comprises applying a keyword search to the keyword-value pairs of the keyword lists.

### BACKGROUND OF THE INVENTION

Embodiments of the present invention relate generally to searching a corpus of information and more particularly to providing flexible, attribute-based search options for searching one or more records for a business object.

Business objects such as orders, invoices, payments, documents, etc., stored in a database or other repository can be searched via applications that use, maintain, or access the information therein. In an enterprise application or other application that provides for searching records of a business object, typically does so through a Structured Query Language (SQL) or similar query against the database. For example, a user can specify through a user interface one or more attributes of the business object to be found. Using the specified attributes, a query can be run against the business object and records containing the specified attributes can be returned or reported to the user.

However, there are many limitations with using an SQL query or similar languages or methods to search a database or other corpus of information. For example, attributes specified as a condition of the search can filter the search results in unnecessary or undesirable ways. That is, specifying a search of more than one attribute with an AND condition, i.e., each attribute is required, can cause results to be filtered that may be relevant even if they do not contain the indicated attribute. If the search is specified using the OR condition instead of AND condition, too many results may be returned. Furthermore, the results are not ordered by relevance such that the important entries appear at the top making it hard for the user to locate what he is looking for. If the search is specified using the combination of AND and OR conditions, it would be very hard for the user to come up with query conditions. Furthermore, if the user is not careful with the search criteria, this would cause relevant results to be filtered. Hence, there is a need for improved methods and systems for searching one or more records of a business object and presenting the results organized by relevance.

### BRIEF SUMMARY OF THE INVENTION

Embodiments of the invention provide systems and methods for searching for records of a business object using a keyword search. A record can be considered to be an instance of the business object. For example, order #123 is an instance or record for the “order” business object. A business object can be stored in a table in the database. A record of a business object can be stored as a row in the table. An attribute for a record can be stored to a column within a row in the table. According to one embodiment, a method of searching for one or more records of a business object can comprise converting one or more records of the business object to one or more keyword lists. Converting records of the business object to one or more keyword lists can comprise converting one or more attributes of each of the records to one or more keyword-value pairs and saving the keyword-value pairs in the keyword lists. In some cases, the keyword-value pairs can be mapped to the attributes of the record.

Records of the business object can be searched based on the keyword lists. Searching for records of a business object based on the keyword lists can comprise applying a keyword search to the keyword-value pairs of the keyword lists. Keyword word search can be done, for example, using a text or keyword search engine. Searching can comprise, for example, identifying records that contain all of the specified attributes, records that contain at least one of a plurality of specified attributes, and/or records that do not contain any of one or more specified attributes. Results of searching the business object can be presented ordered by relevance.

According to another embodiment, a system can comprise a processor and a memory communicatively coupled with and readable by the processor. The memory can contain instructions which, when executed by the processor, cause the processor to convert one or more records of the business object to one or more keyword lists. Converting records of the business object to one or more keyword lists can comprise converting one or more attributes of each of the records to one or more keyword-value pairs and saving the keyword-value pairs in the keyword lists. In some cases, the keyword-value pairs can be mapped to the attributes.

Records of the business object can be searched based on the keyword lists. Searching for records of the business object based on the keyword lists can comprise applying a keyword search to the keyword-value pairs of the keyword lists. Searching can comprise, for example, identifying records that contain all of one or more specified attributes, records that contain at least one of a plurality of specified attributes, and/or records that do not contain any of one or more specified attributes. Results of searching the business object can be presented ordered by relevance.

According to yet another embodiment, a machine-readable medium can have stored thereon a series of instructions which, when executed by a processor, cause the processor to search for one or more records of a business object by converting one or more records of the business object to one or more keyword lists. Converting records of the business object to one or more keyword lists can comprise converting one or more attributes of each of the records to one or more keyword-value pairs and saving the keyword-value pairs in the keyword lists. In some cases, the keyword-value pairs can be mapped to the attributes.

Records of the business object can be searched based on the keyword lists. Searching for records of the business object based on the keyword lists can comprise applying a keyword search to the keyword-value pairs of the keyword lists. Searching can comprise, for example, identifying records that contain all of one or more specified attributes, records that contain at least one of a plurality of specified attributes, and/or records that do not contain any of one or more specified attributes. Results of searching the business object can be presented ordered by relevance.

### BRIEF DESCRIPTION OF THE DRAWINGS

FIG. 1 is a block diagram illustrating components of an exemplary operating environment in which various embodiments of the present invention may be implemented.

FIG. 2 is a block diagram illustrating an exemplary computer system in which embodiments of the present invention may be implemented.

FIG. 3 is a block diagram illustrating, at a high-level, functional components of a system for searching attributes of one or more records of a business object according to one embodiment of the present invention.

FIG. 4 illustrates an exemplary user interface for searching for one or more records of a business object according to one embodiment of the present invention.

FIG. 5 is a flowchart illustrating, at a high-level, a process for searching for one or more records of a business object according to one embodiment of the present invention.

FIG. 6 is a flowchart illustrating additional details of a process for converting attributes of a record of a business object to a keyword list according to one embodiment of the present invention.

FIG. 7 is a flowchart illustrating additional details of a process for searching for one or more records of a business object according to one embodiment of the present invention.

### DETAILED DESCRIPTION OF THE INVENTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes might be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Embodiments of the invention provide systems and methods for searching for one or more records of a business object. More specifically, embodiments of the present invention provide for searching attributes of a business object but with the flexibility provided by a keyword search. For example, a search can be performed on a business object to identify records of the object that contain all, at least one, or none of one or more specified attributes. To perform such a search, attributes of the business object can be converted and mapped to a set of keyword-value pairs and a keyword search can be applied to the set of keyword value pairs. The results of the search can then be presented in order of relevance, i.e., based on the relevance determined by the key-word search.

Stated another way, searching for one or more records of a business object can comprise converting records of the business objects to keyword lists and searching for records of the business object based on the keyword lists. Converting records of the business object to keyword lists can comprise converting one or more attributes of each of the records to one or more keyword-value pairs and saving the keyword-value pairs in the keyword lists. Searching for one or more records of the business object based on the keyword lists can comprise applying a keyword search to the keyword-value pairs of the keyword lists. Additional details of various embodiments of the present invention will be described below with reference to the figures.

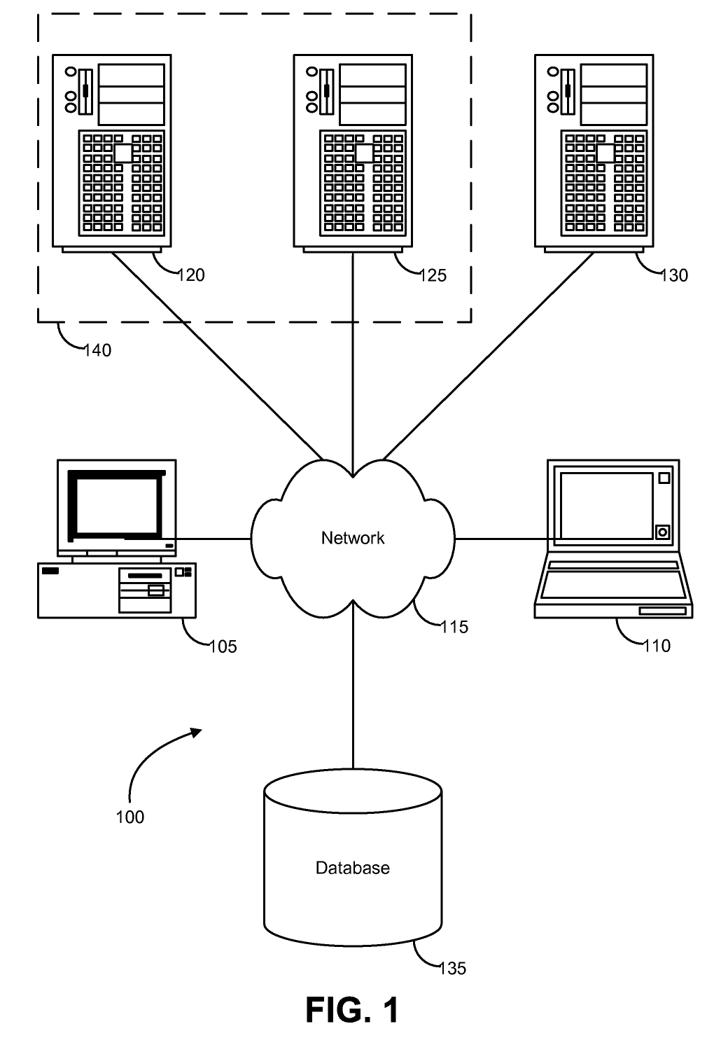

FIG. 1 is a block diagram illustrating components of an exemplary operating environment in which various embodiments of the present invention may be implemented. The system 100 can include one or more user computers 105, 110, which may be used to operate a client, whether a dedicate application, web browser, etc. The user computers 105, 110 can be general purpose personal computers (including, merely by way of example, personal computers and/or laptop computers running various versions of Microsoft Corp.'s Windows and/or Apple Corp.'s Macintosh operating systems) and/or workstation computers running any of a variety of commercially-available UNIX or UNIX-like operating systems (including without limitation, the variety of GNU/Linux operating systems). These user computers 105, 110 may also have any of a variety of applications, including one or more development systems, database client and/or server applications, and web browser applications. Alternatively, the user computers 105, 110 may be any other electronic device, such as a thin-client computer, Internet-enabled mobile telephone, and/or personal digital assistant, capable of communicating via a network (e.g., the network 115 described below) and/or displaying and navigating web pages or other types of electronic documents. Although the exemplary system 100 is shown with two user computers, any number of user computers may be supported.

In some embodiments, the system 100 may also include a network 115. The network may can be any type of network familiar to those skilled in the art that can support data communications using any of a variety of commercially-available protocols, including without limitation TCP/IP, SNA, IPX, AppleTalk®, and the like. Merely by way of example, the network 115 maybe a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth protocol known in the art, and/or any other wireless protocol); and/or any combination of these and/or other networks such as GSM, GPRS, EDGE, UMTS, 3G, 2.5 G, CDMA, CDMA2000, WCDMA, EVDO etc.

The system may also include one or more server computers 120, 125, 130 which can be general purpose computers and/or specialized server computers (including, merely by way of example, PC servers, UNIX servers, mid-range servers, mainframe computers rack-mounted servers, etc.). One or more of the servers (e.g., 130) may be dedicated to running applications, such as a business application, a web server, application server, etc. Such servers may be used to process requests from user computers 105, 110. The applications can also include any number of applications for controlling access to resources of the servers 120, 125, 130.

The web server can be running an operating system including any of those discussed above, as well as any commercially-available server operating systems. The web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 105, 110. As one example, a server may execute one or more web applications. The web application may be implemented as one or more scripts or programs written in any programming language, such as Java™, C, C# or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 105, 110.

In some embodiments, an application server may create web pages dynamically for displaying on an end-user (client) system. The web pages created by the web application server may be forwarded to a user computer 105 via a web server. Similarly, the web server can receive web page requests and/or input data from a user computer and can forward the web page requests and/or input data to an application and/or a database server. Those skilled in the art will recognize that the functions described with respect to various types of servers may be performed by a single server and/or a plurality of specialized servers, depending on implementation-specific needs and parameters.

The system 100 may also include one or more databases 135. The database(s) 135 may reside in a variety of locations. By way of example, a database 135 may reside on a storage medium local to (and/or resident in) one or more of the computers 105, 110, 115, 125, 130. Alternatively, it may be remote from any or all of the computers 105, 110, 115, 125, 130, and/or in communication (e.g., via the network 120) with one or more of these. In a particular set of embodiments, the database 135 may reside in a storage-area network (“SAN”) familiar to those skilled in the art. Similarly, any necessary files for performing the functions attributed to the computers 105, 110, 115, 125, 130 may be stored locally on the respective computer and/or remotely, as appropriate. In one set of embodiments, the database 135 may be a relational database, such as Oracle 10g, that is adapted to store, update, and retrieve data in response to SQL-formatted commands.

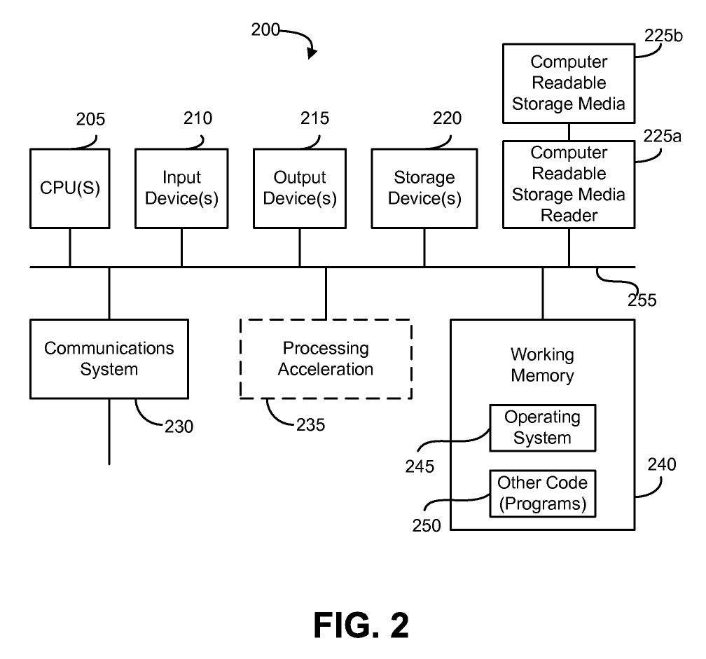

FIG. 2 illustrates an exemplary computer system 200, in which various embodiments of the present invention may be implemented. The system 200 may be used to implement any of the computer systems described above. The computer system 200 is shown comprising hardware elements that may be electrically coupled via a bus 255. The hardware elements may include one or more central processing units (CPUs) 205, one or more input devices 210 (e.g., a mouse, a keyboard, etc.), and one or more output devices 215 (e.g., a display device, a printer, etc.). The computer system 200 may also include one or more storage device 220. By way of example, storage device(s) 220 may be disk drives, optical storage devices, solid-state storage device such as a random access memory (“RAM”) and/or a read-only memory (“ROM”), which can be programmable, flash-updateable and/or the like.

The computer system 200 may additionally include a computer-readable storage media reader 225a, a communications system 230 (e.g., a modem, a network card (wireless or wired), an infra-red communication device, etc.), and working memory 240, which may include RAM and ROM devices as described above. In some embodiments, the computer system 200 may also include a processing acceleration unit 235, which can include a DSP, a special-purpose processor and/or the like.

The computer-readable storage media reader 225a can further be connected to a computer-readable storage medium 225b, together (and, optionally, in combination with storage device(s) 220) comprehensively representing remote, local, fixed, and/or removable storage devices plus storage media for temporarily and/or more permanently containing computer-readable information. The communications system 230 may permit data to be exchanged with the network 220 and/or any other computer described above with respect to the system 200.

The computer system 200 may also comprise software elements, shown as being currently located within a working memory 240, including an operating system 245 and/or other code 250, such as an application program (which may be a client application, web browser, mid-tier application, RDBMS, etc.). It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed. Software of computer system 200 may include code 250 for implementing embodiments of the present invention as described herein.

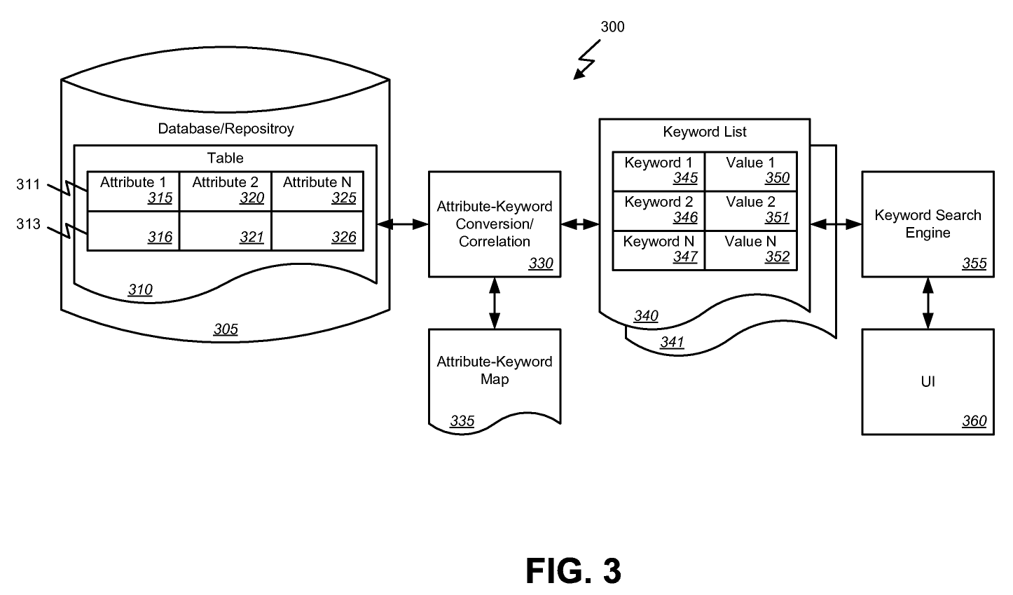

FIG. 3 is a block diagram illustrating, at a high-level, functional components of a system for searching attributes of one or more records of a business object according to one embodiment of the present invention. In this example, the system 300 includes a database 305 or other repository containing a corpus of information. The information in the database 305 can be organized into one or more tables 310. Each table 310 can include a number of records 311 and 313. Record 311 can include attributes 315, 320, and 325 record 313 can include attributes 316, 321, and 326.

As illustrated here, the system 300 can also include an attribute-keyword conversion/correlation module 330. The attribute-keyword conversion/correlation module 330 can be adapted to convert one or more records 311 and 313 of the table 310 or other business object to keyword lists 340 and 341 respectively. That is, according to one embodiment, one record can be converted to one keyword list 340 while another record can be converted to another keyword list 341. For the sake of brevity, conversion of the first record 311 will be described. However, it should be understood that conversion of the second record 313 and the attributes thereof 316, 321, and 326 can be performed in a similar manner.

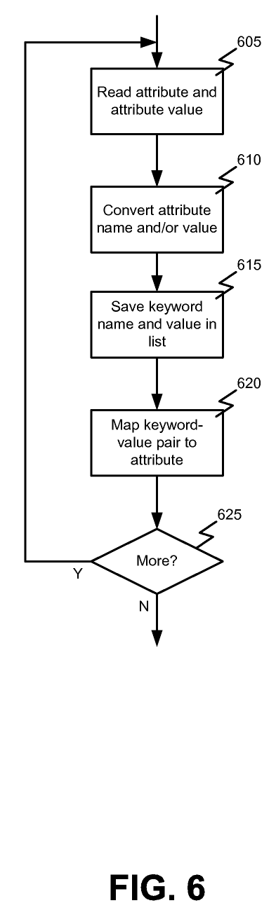

Converting a record 311 to a keyword list 340 can comprise converting one or more attributes 315, 320, and 325 of the record 311 to one or more keyword-value pairs 345 and 350, 346 and 351, and 347 and 352 and saving the keyword-value pairs 345 and 350, 346 and 351, and 347 and 352 in the keyword list 340. Each keyword-value pair 345 and 350, 346 and 351, and 347 and 352 can comprise a keyword name 345, 346, and 347, and a corresponding value 350, 351, and 352 representing the value of the corresponding attribute. As noted, another record 313 can be converted to another keyword list can be performed in a similar manner. That is, the attributes 316, 321, and 326 can be converted to and stored as a set of keyword-value pairs (not shown here) of another keyword list 341. The conversion can be performed periodically, for example, as part of a batch process performed at a designated time, upon the expiration of a time since a previous conversion process, upon an update to the table 310, in response to a request for a search, or upon the occurrence of another event or condition. Additional details of an exemplary conversion process are described below with reference to FIG. 6.

Additionally, the attribute-keyword conversion/correlation module 330 can be adapted to map or correlate the keyword-value pairs 345 and 350, 346 and 351, and 347 and 352 to the attributes 315-326 of the table 310 or business object and, in some cases, save the mapping information in an attribute-keyword map 335. If used, the attribute-keyword map 335 can contain a set of pointers, hyperlinks, or other information linking or correlating an attribute of the table 310 or business object to a corresponding entry in the keyword list 340 that can be used, for example, to read or retrieve a record 311 of the table found to satisfy a search criteria. It should be understood that, while illustrated here as separate from the keyword list 340, in other implementations the attribute-keyword map 335 may be part of the keyword list 340. For example, the keyword list 340 can be expanded to include a pointer or other information identifying the attribute to which the keyword-value pair relates. Alternatively, rather than explicitly mapping the keyword-value pair to an attribute to which it correlates, the name of the keyword can be assigned in a manner to provide the correlation. For example, the keyword name can match or include the attribute name, thus linking or correlating the keyword-value pair to the attribute. In yet other implementations, the keyword list 340 and table 310 may not be linked or mapped at all. Rather, search results may be presented based only on the keyword list 340.

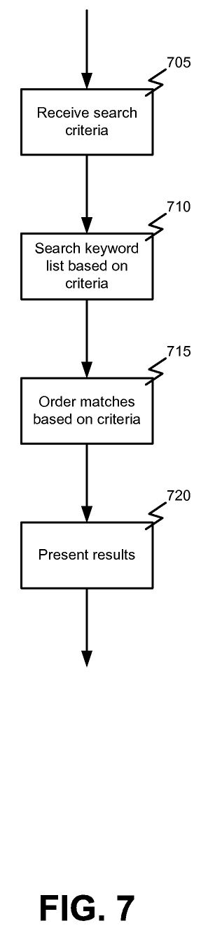

The system 300 can also include a keyword search engine 355 and a user interface 360. Records of the table 310 or business object can be searched by the keyword search engine 355 based on the keyword list 340 and criteria provided by a user via the user interface 360. That is, searching for records of the table 310 based on the keyword list 340 can comprise applying a keyword search to the keyword-value pairs 345 and 350, 346 and 351, and 347 and 352 of the keyword list 340 to identify those keywords and/or values, and thus the corresponding attributes and records of the table 310 matching the user's criteria. Searching can comprise, for example, identifying records that contain all of one or more specified attributes, records that contain at least one of a plurality of specified attributes, and/or records that do not contain any of one or more specified attributes. Results of searching for records of the table can be presented by the keyword search engine 355 via the user interface 360. According to one embodiment, the results can be presented ordered by relevance. Additional details of an exemplary search process will be described below with reference to FIG. 7.

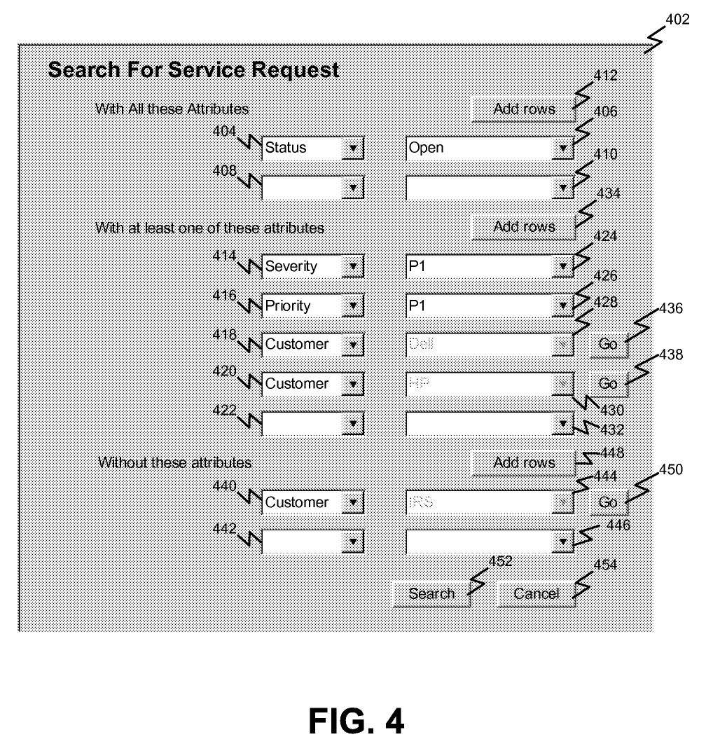

FIG. 4 illustrates an exemplary user interface for searching for one or more records of a business object according to one embodiment of the present invention. In this example, the interface comprises a dialog box 402 made up of a number of elements 404-454. For example, the elements 404-454 of the dialog box can comprise a set of elements 404-410 such as combo-boxes, text boxes, or other elements through which a user can enter attributes and values to be searched and for which results should be presented for records containing all of the indicated attributes (i.e., an “AND” condition). For example, as illustrated here, one element 404 allows the user to enter an attribute (“Status”) and another element 406 allows the user to enter a value (“Open”) for that attribute. The dialog box 402 can also include a button 412 or other element which can be pushed or otherwise manipulated by the user in the event that the user wants to designate attributes in excess of the number of elements 404-410 displayed.

The dialog box 402 can also include a set of elements 414-432 such as combo-boxes, text boxes, or other elements through which a user can enter attributes and values to be searched and for which results should be presented for records containing at least one of the indicated attributes (i.e., an “OR” condition). For example, as illustrated here, one element 414 allows the user to enter an attribute (“Severity”) and another element 424 allows the user to enter a value (“P1”) for that attribute. The dialog box 402 can also include a button 434 or other element which can be pushed or otherwise manipulated by the user in the event that the user wants to designate attributes in excess of the number of elements 414-432 displayed. According to one embodiment, the dialog box can include one or more buttons 436 and 438 for presenting additional options for a particular attribute. For example, a user selection of “Go” buttons 436 and 438 can cause the interface to present a pop-up or new page though which the user can enter or choose from a number of different values and/or other criteria for an attribute.

Similarly, the dialog box 402 can also include a set of elements 440-446 such as combo-boxes, text boxes, or other elements through which a user can enter attributes and values to be searched and for which results should be presented for records containing none of the indicated attributes (i.e., a “NOT” condition). The dialog box 402 can also include a button 448 or other element which can be pushed or otherwise manipulated by the user in the event that the user wants to designate attributes in excess of the number of elements 440-446 displayed. According to one embodiment, the dialog box can include a button 450 for for presenting additional options for a particular attribute. For example, a user selection of “Go” button 450 can cause the interface to present a pop-up or new page though which the user can enter or choose from a number of different values and/or other criteria for an attribute.

Finally, the dialog boxes can include one or more buttons 452 and 454 for controlling the operation of the search. For example, the dialog box 402 can include a “Search” button 452 which can be pushed, selected, or otherwise manipulated by the user to initiate the search as specified by the other elements 404-450 of the dialog box 402. Similarly, the dialog box 402 can include a “Cancel” button 454 which can be pushed, selected, or otherwise manipulated by the user to stop a search in progress.

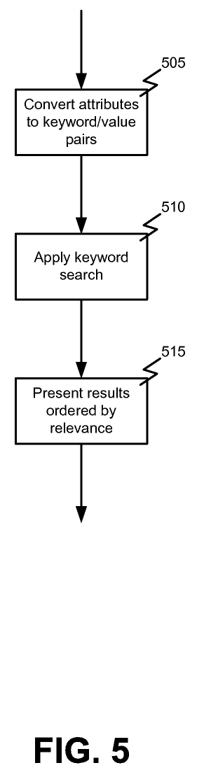

FIG. 5 is a flowchart illustrating, at a high-level, a process for searching for one or more records of a business object according to one embodiment of the present invention. In this example, the process begins with converting 505 one or more records of the business object to one or more keyword lists. For example, the business object can be stored in database tables. Such database tables can comprise business object from an enterprise application. Converting 505 records of the business object to one or more keyword lists can comprise converting 505 one or more attributes of each of the records to one or more keyword-value pairs and saving the keyword-value pairs in the keyword lists. In some cases, the keyword-value pairs can also be mapped to the attributes. Additional details of an exemplary conversion process are described below with reference to FIG. 6.

Records of the business object can be searched based on the keyword list. Searching for records of the business object based on the keyword list can comprise applying 510 a keyword search to the keyword-value pairs of the keyword list. Searching can comprise, for example, identifying records that contain all of one or more specified attributes, records that contain at least one of a plurality of specified attributes, and/or records that do not contain any of one or more specified attributes. Results of searching the business objects can be presented 515 ordered by relevance. Additional details of an exemplary search process will be described below with reference to FIG. 7.

FIG. 6 is a flowchart illustrating additional details of a process for converting attributes of records of a business object to a keyword list according to one embodiment of the present invention. As noted above, such a process can be performed periodically, for example, as part of a batch process performed at a designated time, upon the expiration of a time since a previous conversion process, upon an update to the business object, in response to a request for a search, or upon the occurrence of another event or condition. In this example, the process begins with reading 605 an attribute of a record of the business object. For example, reading an attribute of a record of the business object can comprise reading a name and value of an attribute of the record of a database table or other object as described above.

The attribute can be converted 610 to a keyword-value pair as described above. As noted, each keyword-value pair can comprise a keyword name which may or may not indicate or identify the corresponding attribute and a value that represents the value of the attribute. Furthermore, converting 610 the attribute to a keyword-value pair may, in some cases comprise changing or converting the data type and/or format of the attribute. For example, converting 610 the attribute may comprise changing the name and/or the value of the attribute to a text format. The exact data type and/or format used can vary significantly between implementations without departing from the scope of the present invention. Regardless of the exact format, the keyword-value pair can be saved 615 in a keyword list such as described above.

In some cases, the keyword-value pair may also be mapped 620 to the corresponding attribute. As noted, if used, a map of the keyword-value pairs and attributes can contain a set of pointers, hyperlinks, or other information linking or correlating an attribute of the business object to a corresponding entry in the keyword list. Alternatively, rather than explicitly mapping the keyword-value pair to an attribute to which it correlates, the name of the keyword can be assigned in a manner to provide the correlation. For example, the keyword name can match or include the attribute name, thus linking or correlating the keyword-value pair to the attribute.

Regardless of whether or how the attribute and key-word value pair may be mapped, a determination 625 can then be made as to whether further conversions should be performed. In response to determining 625 that more attributes remain to be converted, processing can return to reading 605 an attribute from a record of the business object. That is, processing can continue with reading 605 an attribute from a record of the business object, converting 610 the attribute to a keyword-value pair, saving 615 the keyword value pair in a keyword list, and possibly mapping 620 the keyword-value pair to the attribute until all or some designated subset of all attributes are converted.

FIG. 7 is a flowchart illustrating additional details of a process for searching for one or more records of a business object according to one embodiment of the present invention. In this example, the process begins with receiving 705 a search criteria. For example, receiving 705 a search criteria can comprise receiving one or more attributes, attribute values, and/or other criteria from a user via a user interface as described above. The keyword list can then be searched 710 for or based on the received criteria. Searching 710 the keyword list can be performed, for example, using a keyword search or text search engine as known in the art. That is a keyword search can be applied to the keyword-value pairs of the keyword list to identify those keywords and/or values, and thus the corresponding attributes and records of the business object matching the search criteria. Searching can comprise, for example, identifying records that contain all of one or more specified attributes, records that contain at least one of a plurality of specified attributes, and/or records that do not contain any of one or more specified attributes. The results, i.e., an indication of those attributes matching the search criteria can be ordered 715 by relevance and presented or reported 720 to the user, for example for a display or other user interface.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method of searching for one or more records of a business object, the method comprising:
converting one or more records of the business object to one or more keyword lists; and
searching for records of the business object based on the keyword lists.

2. The method of claim 1, wherein converting the one or more records of the business object to one or more keyword lists comprises:
converting one or more attributes of each of the records to one or more keyword-value pairs; and
saving the keyword-value pairs in the keyword lists.

3. The method of claim 2, further comprising mapping the keyword-value pairs to the attributes.

4. The method of claim 2, wherein searching for records of the business object based on the keyword lists comprises applying a keyword search to the keyword-value pairs of the keyword lists.

5. The method of claim 4, further comprising presenting results of searching the business object ordered by relevance.

6. The method of claim 1, wherein the business object comprises a database table.

7. The method of claim 6, wherein the database table comprises a database table used by an enterprise application.

8. The method of claim 1, wherein searching comprises identifying records that contain all of one or more specified attributes.

9. The method of claim 1, wherein searching comprises identifying records that contain at least one of a plurality of specified attributes.

10. The method of claim 1, wherein searching comprises identifying records that do not contain any of one or more specified attributes.

11. A system comprising:
a processor; and
a memory communicatively coupled with and readable by the processor, the memory containing instructions which, when executed by the processor, cause the processor to convert one or more records of a business object to one or more keyword lists and search for records of the business object based on the keyword lists.

12. The system of claim 11, wherein converting the one or more records of the business object to one or more keyword lists comprises:
converting one or more attributes of each of the records to one or more keyword-value pairs; and
saving the keyword-value pairs in the keyword lists.

13. The system of claim 12, further comprising mapping the keyword-value pairs to the attributes.

14. The system of claim 12, wherein searching for records of the business object based on the keyword lists comprises applying a keyword search to the keyword-value pairs of the keyword lists.

15. The system of claim 14, further comprising presenting results of searching the business objects ordered by relevance.

16. The system of claim 11, wherein the business object comprises a database table.

17. The system of claim 16, wherein the database table comprises a table used by an enterprise application.

18. The system of claim 11, wherein searching comprises identifying records that contain all of one or more specified attributes.

19. The system of claim 11, wherein searching comprises identifying records that contain at least one of a plurality of specified attributes.

20. The system of claim 11, wherein searching comprises identifying records that do not contain any of one or more specified attributes.

21. A machine-readable medium having stored thereon a series of instructions which, when executed by a processor, cause the processor to search for records of a business object by:
converting one or more records of the business object to one or more keyword lists; and
searching for records of the business object based on the keyword lists.

22. The machine-readable medium of claim 21, wherein converting the one or more records of the business object to one or more keyword lists comprises:
converting one or more attributes of each of the records to one or more keyword-value pairs; and
saving the keyword-value pairs in the keyword lists.

23. The machine-readable medium of claim 22, further comprising mapping the keyword-value pairs to the attributes.

24. The machine-readable medium of claim 22, wherein searching for records of the business object based on the keyword lists comprises applying a keyword search to the keyword-value pairs of the keyword lists.

25. The machine-readable medium of claim 24, further comprising presenting results of searching the business objects ordered by relevance.

26. The machine-readable medium of claim 21, wherein the business object comprises a database table.

27. The machine-readable medium of claim 26, wherein the database table comprise a table used by an enterprise application.

28. The machine-readable medium of claim 21, wherein searching comprises identifying records that contain all of one or more specified attributes.

29. The machine-readable medium of claim 21, wherein searching comprises identifying records that contain at least one of a plurality of specified attributes.

30. The machine-readable medium of claim 21, wherein searching comprises identifying records that do not contain any of one or more specified attributes.
